(19) United States
(12) Patent Application Publication
(10) Pub. No.: US 2014/0187233 A1
(43) Pub. Date: Jul. 3, 2014

(54) WATCH TYPE MOBILE TERMINAL

(71) Applicant: COMPAL COMMUNICATIONS, INC., Taipei (TW)

(72) Inventors: Yung-Hsiang Chen, Taipei (TW); Chang-Hua Wei, Taipei (TW); Wei-Chih Hsu, Taipei (TW); Shi-Kuan Chen, Taipei (TW); Chuan-Hao Wen, Taipei (TW); Ming-Yu Tseng, Taipei (TW); Po-Yi Wu, Taipei (TW); Yi-Chen Lin, Taipei (TW); Yi-Chu Hsu, Taipei (TW); Chih-Hsiang Fang, Taipei (TW); Pang-Ruei Huang, Taipei (TW); Lien-Chih Tsai, Taipei (TW); Yen-Hui Li, Taipei (TW); Yung-Ching Tien, Taipei (TW)

(73) Assignee: COMPAL COMMUNICATIONS, INC., Taipei (TW)

(21) Appl. No.: 13/727,616

(22) Filed: Dec. 27, 2012

(51) Int. Cl. H04M 1/02

(52) U.S. Cl. CPC H04M 1/0279
USPC 455/422.1; 455/575.6; 455/566

(57) ABSTRACT

A watch type mobile terminal capable of being worn on a user's wrist is provided. The watch type mobile terminal includes a case, a circuit board, a first connector, a band, a receiver and a first flexible printed circuit (FPC) board. The circuit board is disposed in the case. The first connector is disposed on the circuit board. The band is connected to the case, whereby the watch type mobile terminal is capable of being worn on the user's wrist, and the band has a first end and a second end opposite to the first end. The receiver is disposed at the first end. The first FPC board is disposed in the band and connected between the first connector and the receiver.

### BACKGROUND OF THE INVENTION

1. Field of the Invention

The present invention generally relates to a mobile terminal More particularly, the present invention relates to a watch type mobile terminal.

2. Description of Related Art

In general, mobile terminals keep pace with compactness and slimness of electronic parts. Bar-type mobile terminals as 1^{St} generation and flip-type mobile terminals as 2^{nd} generation have come into wise use. At present, flip-type mobile terminals and folder-type mobile terminals as 3^{rd} generation are generally used together. Watch-type mobile terminals that are wearable on users' bodies or wrists have also been developed.

A watch type mobile terminal is a device that can be carried around and has one or more functions such as voice and video call communication, inputting and outputting information, storing data, and the like. Moreover, because of being worn on a user's body or wrist, the watch-type mobile terminal has improved portability and prevents a risk of loss or destruction due to dropping or shock caused by a careless mistake during use.

However, in use, when the user has a speaker portion of watch-type mobile terminal brought into contact with his/her ear to answer a phone call, it is impossible for the user to have a microphone portion of watch-type mobile terminal disposed adjacent to his/her mouth, which makes it difficult for the microphone portion to catch the user's voice sound, and it is also hard for a user to speak in a whisper without making the people around the user uncomfortable. Further, in the case where an external earphone is used in place of the speaker portion of this watch-type mobile terminal, an electric connecting cord extending from the user's wrist to his/her ear is a must for such wrist-mounted type unit. However, the presence of this connecting cord impairs such watch-type mobile terminal in wear-ability (i.e., suitability for being worn).

As described above, the watch-type mobile terminal, which is much smaller in size than a conventional cell phone and the like, suffers from various types of disadvantages and a watch-type mobile terminal which could improve the above disadvantages is needed to be developed.

### SUMMARY OF THE INVENTION

Accordingly, the present invention is directed to a watch type mobile terminal, which is more convenient for a user to answer/dial phone calls and enables the user to speak in whisper without making the people around the user uncomfortable.

The present invention provides a watch type mobile terminal including a case, a band and a receiver. The case has a circuit board and a first connector disposed therein, the first connector is disposed on the circuit board. The band is connected to the case and has a first flexible printed circuit (FPC) board, whereby the watch type mobile terminal is capable of being worn on the user's wrist, and the band has a first end and a second end opposite to the first end. The receiver is disposed at the first end, whereby the first FPC board is disposed between the first connector and the receiver.

According to an embodiment of the present invention, the watch type mobile terminal further includes a speaker and a microphone disposed on the case and coupled to the circuit board.

According to an embodiment of the present invention, the material of the band comprises metal spring covered with silicone rubber or thermoplastic polyurethane (TPU).

According to an embodiment of the present invention, the watch type mobile terminal further includes a display panel disposed on a top surface of the case and coupled to the circuit board.

According to an embodiment of the present invention, the watch type mobile terminal further includes a receiver housing disposed at the first end and covering the receiver, wherein the receiver housing has a sound hole exposing part of the receiver.

According to an embodiment of the present invention, the receiver housing comprises a top housing and a bottom housing engaged with each other so as to together covering the receiver.

According to an embodiment of the present invention, the watch type mobile terminal further includes a second flexible printed circuit (FPC) board, a second connector and a universal serial bus (USB) plug. The second connector is disposed on the circuit board. The USB plug is disposed at the second end. The second FPC board is disposed in the band and connected between the second connector and the USB plug.

According to an embodiment of the present invention, the watch type mobile terminal further includes a universal serial bus (USB) housing, slidably disposed at the second end and having an opening exposing the USB plug. When the USB housing slides away from the case, the USB plug is located within the USB housing, when the USB housing slides toward to case, the USB plug is protruded out of the USB housing from the opening.

Based on the above, the receiver of the watch type mobile terminal of the present invention is disposed at one end of the band, and the receiver is electrically connected to the circuit board in the case by the FPC board. With the disposition, when a phone call is received by the watch type mobile terminal, the user may place the end of the band having the receiver to the position between the user's thumb and index finger, so the receiver is located in the user's palm. Therefore, the receiver of the watch type mobile terminal is closer to the user's ear when answering the phone call. Moreover, the user's hand can shield some background noise from the noisy environment so it is easier for watch type mobile terminal to catch the user's sound. In addition, the user can also use his hand to partially cover his mouth when talking, so the user may speak in a whisper without making the people around the user feel uncomfortable.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a watch type mobile terminal according to an embodiment of the present invention.

FIG. 2 is a partial perspective view of the watch type mobile terminal in FIG. 1.

FIG. 3 is a perspective view of the case in FIG. 1.

FIG. 4 is a cross-sectional view of the first end in FIG. 1.

FIG. 5 is a cross-sectional view of the second end in FIG. 1.

FIG. 6 illustrates a scenario of a user wearing the watch type mobile terminal in FIG. 1.

FIG. 7 illustrates a scenario of a user answering a phone call by the watch type mobile terminal in FIG. 1.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

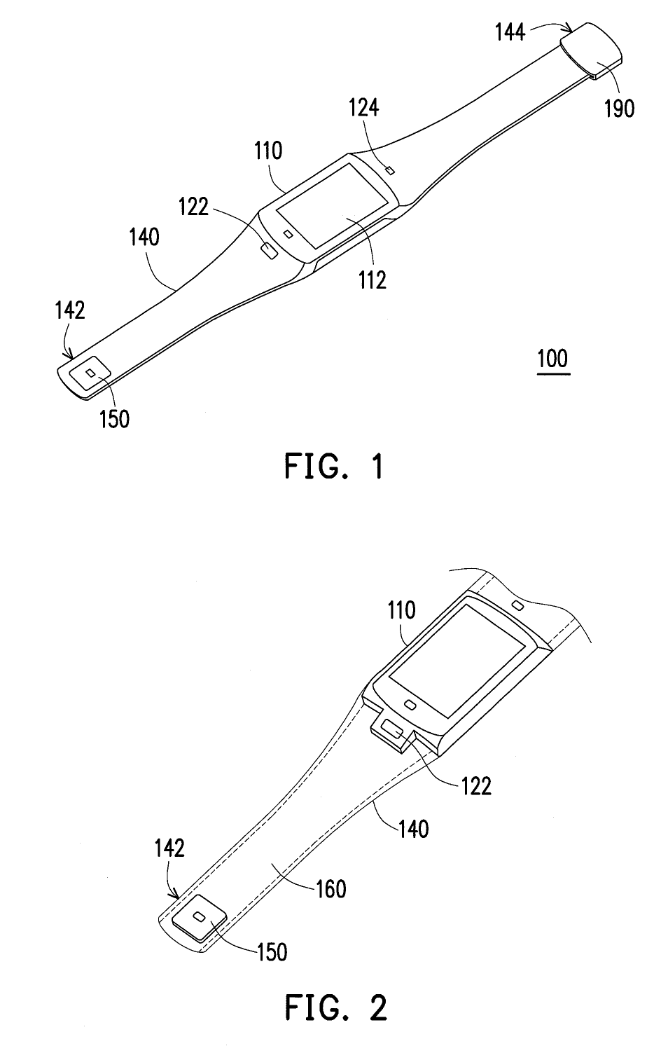

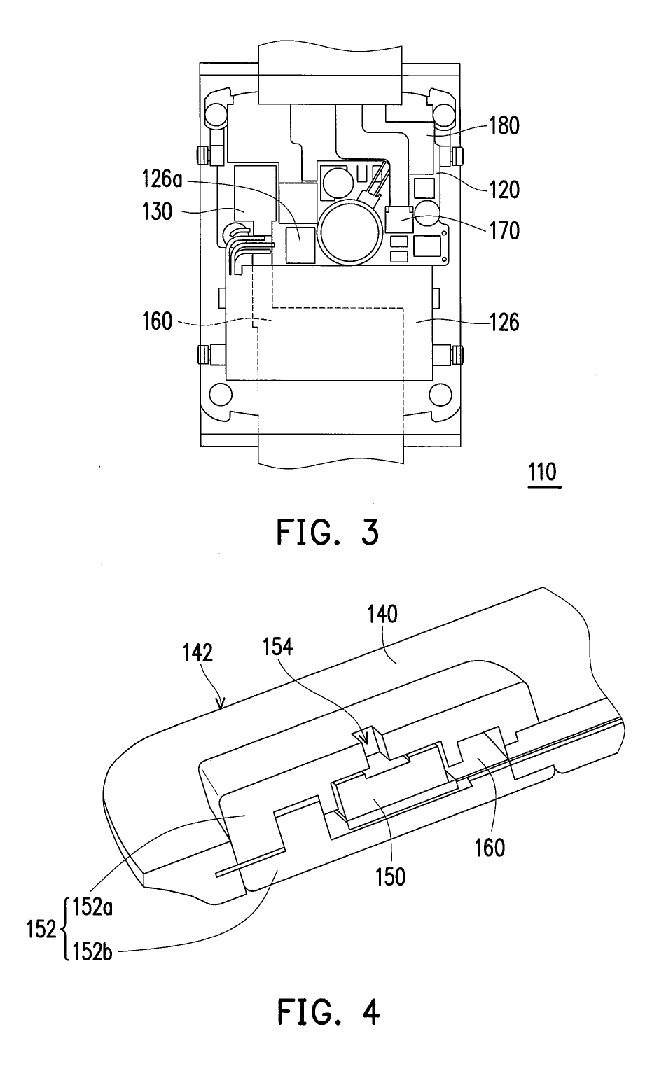

FIG. 1 is a schematic view of a watch type mobile terminal according to an embodiment of the present invention. FIG. 2 is a partial perspective view of the watch type mobile terminal in FIG. 1. FIG. 3 is a perspective view of the case in FIG. 1. Referring to FIG. 1, FIG. 2 and FIG. 3, the watch type mobile terminal 100 of the present embodiment is capable of being worn on a user's wrist. In the present embodiment, the watch type mobile terminal 100 is, for example, a watch type mobile phone. The watch type mobile terminal 100 includes a case 110, a band 140 and a receiver 150. The case 110 has a circuit board 120 and a first connector 130 disposed therein, as shown in FIG. 3. The first connector 130 is disposed on the circuit board 120. In the present embodiment, the watch type mobile terminal 100 further includes a speaker 122, a microphone 124 and a display panel. The speaker 122 and the microphone 124 is disposed on the case 110 as shown in FIG. 2 and is coupled to the circuit board 120. The display panel 112 disposed on a top surface of the case 110 as shown in FIG. 1 and FIG. 2 and is coupled to the circuit board 120. The watch type mobile terminal 100 may further includes a battery 126 which is disposed in the case 110 and a battery connector 126a disposed on the circuit board 120 and connected to the battery 126 for electrically connecting the battery 126 and the circuit board 120.

Referring to FIG. 2 and FIG. 3, the band 140 is connected to the case 110 and has a first end 142, a second end 144 opposite to the first end 142 and a first flexible printed circuit (FPC) board 160. In the present embodiment, the material of the band 140 is, for example, metal spring covered with silicone rubber or thermoplastic polyurethane (TPU), such that the watch type mobile terminal 100 is capable of being worn on the user's wrist as a conventional watch is. The receiver 150 is disposed at the first end 142 of the band 140, whereby the first FPC board 160 is disposed within the band 140 and connected between the first connector 130 and the receiver 150. That is to say, the receiver 150 is disposed at the first end 142 of the band 140 and is electrically connected to the circuit board 120 through the first connector 130 and the first FPC board 160.

FIG. 4 is a cross-sectional view of the first end in FIG. 1. Referring to FIG. 4, in the present embodiment, the watch type mobile terminal 100 further includes a receiver housing 152, which is disposed at the first end 142 and covers the receiver 150. The receiver housing 152 has a sound hole 154 aligned with and exposing part of the receiver 150. Therefore, the sound emitted from the receiver 150 can be directly transmitted to the sound hole 154 and can be received by the user when the user's ear approaches the sound hole 154. To be more specific, the receiver housing 152 is composed of a top housing 152a and a bottom housing 152b, which are engaged with each other so as to cover the receiver 150. In the present embodiment, the top housing 152a and the bottom housing 152b are fixed to each other by, for example, glue dispensing process. The sound hole 154 may be disposed either on the top housing 152a or on the bottom housing 152b. The present invention is not limited thereto.

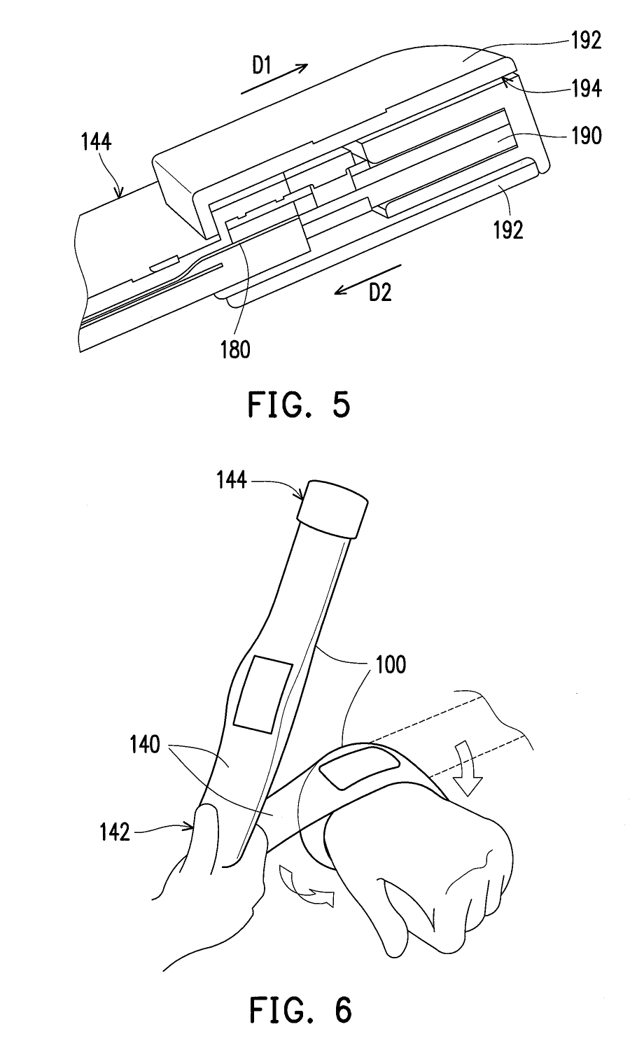

FIG. 5 is a cross-sectional view of the second end in FIG. 1. Referring to FIG. 3 and FIG. 5, in the present embodiment, the watch type mobile terminal 100 further includes a second flexible printed circuit (FPC) board 180, a second connector 170 and a universal serial bus (USB) plug 190. The second connector 170 is disposed on the circuit board 120 as shown in FIG. 3. The USB plug 190 is disposed at the second end 144 as shown in FIG. 5. The second FPC board 180 is disposed within the band 140 and is connected between the second connector 170 and the USB plug 190. In other words, the USB plug 190 is disposed at the second end 144 of the band 140 and is electrically connected to the circuit board 120 through the second connector 170 and the second FPC board 180. In addition, the watch type mobile terminal 100 of the present embodiment further includes a USB housing 192, which is slidably disposed at the second end 144 and has an opening 194 exposing the USB plug 190 as shown in FIG. 5. The USB housing 192 is capable of sliding away from the case 110, which is the first direction D1, and sliding toward the case 110, which is the second direction D2. When the USB housing 192 slides along the first direction D1, the USB housing 192 covers the USB plug 190 and the USB plug 190 is located within the USB housing 192 as shown in FIG. 5. When the USB housing 192 slides along the second direction D2, the USB plug 190 is protruded out of the USB housing 192 from the opening 194, so the USB plug 190 can be plugged into a USB receptacle (not shown). Therefore, the watch type mobile terminal 100 can be electrically connected to an electronic device (not shown) having USB receptacle by the USB plug 190 for charging or other purposes. The electronic device having USB receptacle is, for example, a charger, a laptop, etc.

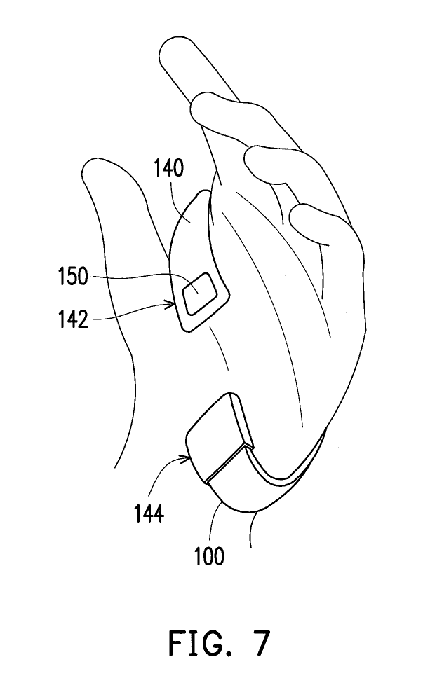

FIG. 6 illustrates a scenario of a user wearing the watch type mobile terminal in FIG. 1. Referring to FIG. 6, with the disposition described above, a user may use the flexibility of the band 140 to wear the watch type mobile terminal 100 on one's wrist as shown in FIG. 6. To be more specific, in the present embodiment, the method for wearing the watch type mobile terminal 100 described above includes the following steps: firstly, when a user wants to wear the watch type mobile terminal 100 of the present embodiment on his wrist, the user may pull both the first end 142 and the second end 144 away from each other to straighten the band 140 of watch type mobile terminal 100 temporarily. Then, the user may hold one of the first end 142 and the second end 144 with one hand, and move the watch type mobile terminal 100 toward the wrist of the user's the other hand. When contacting the user's wrist, the band 140 of the watch type mobile terminal 100 is bent and circling the user's wrist, so as to fix the watch type mobile terminal 100 on the user's wrist.

FIG. 7 illustrates a scenario of a user answering a phone call by the watch type mobile terminal in FIG. 1. Referring the FIG. 7, in the present embodiment, the method for answering incoming call with the watch type mobile terminal 100 described above includes the following steps: firstly, when a phone call is received by the watch type mobile terminal 100 of the present embodiment, the user pulls the first end 142 a way from the user's wrist and place the band 140 connected to the first end 142 onto the position between the user's thumb and index finger as shown in FIG. 7, so the first end 142 with the receiver 150 disposed thereon is located in the user's palm as shown in FIG. 7, and the user approaches his ear with his hand which the receiver 150 is located in the palm to answer the phone call. In such manner, the receiver 150 is closer to the user's ear. Moreover, the user's hand may shield some background noise from the noisy environment so it is easier for watch type mobile terminal 100 to catch the user's sound, and the user may also use his hand to partially cover his mouth when talking. Therefore, the user may speak in a whisper without making the people around the user feel uncomfortable.

In an embodiment of the present invention which is not illustrated herein, a receiving bottom (not shown) may be disposed at the first end. The receiving bottom may also be electrically connected to the circuit board through the first FPC board, so the user may firstly place the first end at the position between his thumb and his index finger, and then press the receiving bottom located at the first end to answer the phone call. In other embodiment, the watch type mobile terminal may further includes a pressure sensor (not shown) disposed at the first end. When a phone call is received by the watch type mobile terminal, the user places the first end at the position between his thumb and his index finger, and a pulling pressure applied by the user at the first end is detected by the pressure sensor. Then, a call-answering operation is performed according to the pulling pressure. More specifically, the watch type mobile terminal may further a control unit (not shown) disposed on the circuit board, and pressure sensor may be electrically connected to the control unit by the first FPC board. When the pulling pressure applied by the user at the first end is detected by the pressure sensor, a detecting signal is sent to the control unit by the pressure sensor, and the control unit controls the watch type mobile terminal to perform a call-answering operation according to the detecting signal. Therefore, a phone call can be automatically answered by placing the first end of the watch type mobile terminal at the position between the user's thumb and the user's index finger without pressing any bottoms or keys.

In sum, the receiver of the watch type mobile terminal of the present invention is disposed at one end of the band, and the receiver is electrically connected to the circuit board in the case by the FPC board. With the disposition, when a phone call is received by the watch type mobile terminal, the user may place the end of the band having the receiver to the position between the user's thumb and index finger, so the receiver is located in the user's palm. Therefore, the receiver of the watch type mobile terminal is closer to the user's ear when answering the phone call. Moreover, the user's hand can shield some background noise from the noisy environment so it is easier for watch type mobile terminal to catch the user's sound. In addition, the user can also use his hand to partially cover his mouth when talking, so the user may speak in a whisper without making the people around the user feel uncomfortable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A watch type mobile terminal comprising:
a case, having a circuit board and a first connector disposed therein, the first connector disposed on the circuit board;
a band, connected to the case and having a first flexible printed (FPC) board, whereby the watch type mobile terminal is capable of being worn on the user's wrist, and the band has a first end and a second end opposite to the first end; and
a receiver, disposed at the first end, whereby the first flexible printed circuit (FPC) board is disposed between the first connector and the receiver.

2. The watch type mobile terminal as claimed in claim 1, further comprises a speaker and a microphone disposed on the case and coupled to the circuit board.

3. The watch type mobile terminal as claimed in claim 1, wherein the material of the band comprises metal spring covered with silicone rubber or thermoplastic polyurethane (TPU).

4. The watch type mobile terminal as claimed in claim 1, further comprising a display panel disposed on a top surface of the case and coupled to the circuit board.

5. The watch type mobile terminal as claimed in claim 1, further comprising a receiver housing disposed at the first end and covering the receiver, wherein the receiver housing has a sound hole exposing part of the receiver.

6. The watch type mobile terminal as claimed in claim 5, wherein the receiver housing comprises a top housing and a bottom housing engaged with each other so as to together covering the receiver.

7. The watch type mobile terminal as claimed in claim 1, further comprises a second flexible printed circuit (FPC) board, a second connector and a universal serial bus (USB) plug, the second connector is disposed on the circuit board, the USB plug is disposed at the second end, and the second FPC board is disposed in the band and connected between the second connector and the USB plug.

8. The watch type mobile terminal as claimed in claim 1, further comprises a universal serial bus (USB) housing, slidably disposed at the second end and having an opening exposing the USB plug, when the USB housing slides away from the case, the USB plug is located within the USB housing, when the USB housing slides toward to case, the USB plug is protruded out of the USB housing from the opening.

9. A method for wearing the watch type mobile terminal as claimed in claim 1, comprising:
pulling both the first end and the second end away from each other to straighten the band of the watch type mobile terminal temporarily; and
moving the watch type mobile terminal toward a user's wrist, when contacting the user's wrist, the band of the watch type mobile terminal bent and circling the user's wrist, so as to fix the watch type mobile terminal on the user's wrist.

10. A method for answering incoming call, applicable to the watch type mobile terminal as claimed in claim 1, comprising:
receiving an incoming call;
pulling the first end of the band a way from a user's wrist and placing the band connected to the first end onto a position between the user's thumb and index finger, so the first end with the receiver disposed thereon is located in the user's palm; and
approaching the user's ear with the user's palm which the receiver is located therein to answer the incoming call.
